(19) United States
(12) Patent Application Publication
(10) Pub. No.: US 2026/0184858 A1
(43) Pub. Date: Jul. 2, 2026

(54) MICROCAPSULE AND COMPOSITION EMPLOYING THE SAME

(71) Applicant: INDUSTRIAL TECHNOLOGY RESEARCH INSTITUTE, Hsinchu (TW)

(72) Inventors: Yi-Chun CHEN, Hsinchu City (TW); Yeu-Ding CHEN, Zhunan Township (TW); Chih-Hao LIN, Taoyuan City (TW); Kai-Chi CHEN, Zhubei City (TW)

(73) Assignee: INDUSTRIAL TECHNOLOGY RESEARCH INSTITUTE, Hsinchu (TW)

(21) Appl. No.: 19/003,823

(22) Filed: Dec. 27, 2024

(51) Int. Cl. C08J 3/12; C08L 63/00; C08L 75/02

(52) U.S. Cl. CPC C08J 3/126; C08L 63/00; C08L 75/02

(57) ABSTRACT

A microcapsule is provided and a composition employing the same is also provided. The microcapsule includes an organometallic promoter and a polyurea, wherein the polyurea is encapsulated the organometallic promoter. In particular, the amount of the organometallic promoter in the microcapsule is 5 wt % to 50 wt %, based on the weight of the microcapsule.

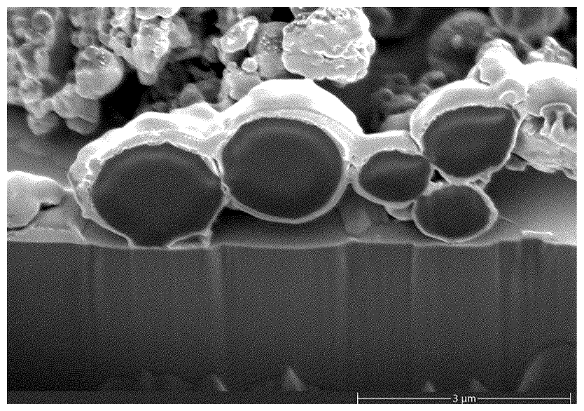

### TECHNICAL FIELD

The disclosure relates to a microcapsule and a compositions employing the same.

### BACKGROUND

Epoxy resin is widely used in a variety of fields as an insulating material, sealing material, adhesive, and conductive material for electronic components. Higher demands have been placed on the production efficiency, portability, and reliability of electronic devices for mobile applications, especially with the enhancement of electronic device functions, the reduction in size and thickness, as well as the miniaturization of semiconductor chips and the increase in circuit density.

Conventional epoxy resin compositions used for semiconductor packaging require high-temperature and long-duration curing (at a curing temperature of about 150° C.-180° C. and a curing time of about 2 to 4 hours), leading to increased carbon emissions. With the global trend towards net-zero carbon emissions, the semiconductor industry will inevitably face a demand for carbon reduction.

Due to the low reactivity between epoxy resin and aromatic amine hardeners, high curing temperatures and long curing times are generally required to produce high-performance crosslinked polymer materials. The increasing curing temperature and time lead to higher processing costs and lower production efficiency, thereby limiting the application of aromatic amine hardeners. Accelerators used in epoxy resin compositions can speed up the reaction and enable curing at lower temperatures. However, epoxy resin compositions including conventional accelerators often have poor storage stability, deteriorating the stability of the resin composition at room temperature and its workability.

Therefore, the industry is actively developing novel epoxy resin compositions.

### SUMMARY

According to embodiments of the disclosure, the disclosure provides a microcapsule. The microcapsule includes an organometallic promoter, and a polyurea, wherein the polyurea encapsulates the organometallic promoter. The amount of organometallic promoter in the microcapsule may be 5 wt % to 50 wt %, based on the weight of the microcapsule. The organometallic promoter is organotin compound, organochromium compound, or a combination thereof.

According to embodiments of the disclosure, the disclosure also provides a composition (such as thermal curing composition). The composition includes a liquid aromatic epoxy resin, an aromatic multi-amine compound, and the microcapsule of the disclosure.

A detailed description is given in the following embodiments.

### BRIEF DESCRIPTION OF THE DRAWINGS

The present disclosure can be more fully understood by reading the subsequent detailed description and examples with references made to the accompanying drawings, wherein:

FIGURE is a focused ion beam-scanning electron microscope (FIB-SEM) image of Microcapsule (1) of the disclosure.

### DETAILED DESCRIPTION

The microcapsule and compositions employing the same are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Furthermore, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

Embodiments of the disclosure provide a microcapsule that can be applied in the epoxy resin curing process (such as an one-component encapsulation resin system). The microcapsule of the disclosure includes an organometallic promoter and polyurea, wherein the organometallic promoter can be encapsulated by polyurea to form the microcapsule. In addition, embodiments of the disclosure provide a composition (such as an epoxy resin composition) that includes the microcapsule of the disclosure. Since the organometallic promoter within the microcapsule is protected by polyurea at room temperature, it does not react with other components of the composition. When the composition is heated, the microcapsule softens and releases the promoter, thereby accelerating the curing process, lowering the reaction temperature, and reducing power consumption. Accordingly, by incorporating the microcapsule of the disclosure along with a liquid aromatic epoxy resin and an aromatic polyamine compound, the composition of the disclosure can achieve rapid curing at a relatively low temperature (such as 130° C. to 150° C. within 2 to 4 hours), while simultaneously maintaining good reactivity and storage stability.

According to embodiments of the disclosure, the microcapsule of the disclosure includes an organometallic promoter and polyurea. The polyurea encapsulates the organometallic promoter to form the microcapsule. In some embodiments, the microcapsule may have an inner layer composed of the organometallic promoter and an outer layer of polyurea cladding, or an inner layer composed of a mixture of polyurea and the organometallic promoter, with an outer layer of polyurea cladding.

According to embodiments of the disclosure, the amount of organometallic promoter in the microcapsule may be 5 wt % to 50 wt % (such as 10 wt %, 15 wt %, 20 wt %, 25 wt %, 30 wt %, 35 wt %, 40 wt %, or 45 wt %), depending on the weight of the microcapsule. If the organometallic promoter content is too low, the amount of promoter released upon heating may be insufficient to effectively enhance the reactivity of the composition. Conversely, if the organometallic promoter content is too high, the encapsulation effect may be compromised.

According to embodiments of the disclosure, the organometallic promoter may be an organotin promoter, an organochromium promoter, or a combination thereof. According to embodiments of the disclosure, the organotin (II) compound may be a divalent tin metal complex, such as a divalent tin metal complex with a carboxylate ligand.

According to embodiments of the disclosure, the organometallic promoter is stannous octoate, tin(II) acetylacetonate, tin(II) acetate, tin(II) oxalate, chromium(III) octoate, chromium(III) acetylacetonate, chromium(III) acetate, chromium(III) oxalate, or a combination thereof.

According to embodiments of the disclosure, the polyurea may be a polymer of an isocyanate prepolymer. According to embodiments of the disclosure, the isocyanate prepolymer may have a structure of Formula (I)

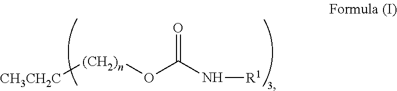

wherein n may be 1, 2, 3, 4, 5, or 6; and R¹ may be independently

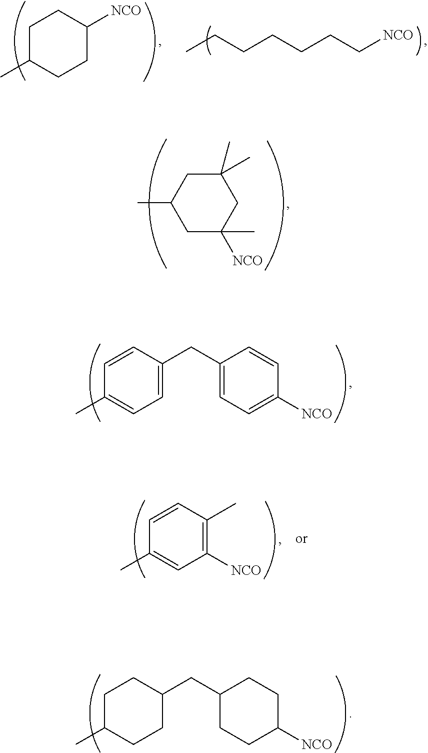

According to embodiments of the disclosure, the particle size distribution D50 of the microcapsule of the disclosure may be 0.5 μm to 600 μm (such as 1 μm, 5 μm, 10 μm, 20 μm, 50 μm, 80 μm, 100 μm, 200 μm, 300 μm, 400 μm, 450 μm, 500 μm, or 550 μm). As a result, the composition including the microcapsule can exhibit room temperature storage stability. Further, after heating, the microcapsule can release the promoter, enhancing the reactivity of the composition. The particle size distribution D50 of the microcapsule is measured by dynamic light scattering (DLS).

According to embodiments of the disclosure, the disclosure also provides a thermo curing composition, such as a thermo curing epoxy resin composition. According to embodiments of the disclosure, the composition includes a liquid aromatic epoxy resin, an aromatic multi-amine compound, and the microcapsule of the disclosure.

According to embodiments of the disclosure, the liquid aromatic epoxy resin in the composition may be a liquid aromatic epoxy resin with at least two terminal epoxy groups. The liquid aromatic epoxy resin is defined as an aromatic epoxy resin that remains in a liquid state at room temperature (about 18° C. to 35° C.). Furthermore, the liquid aromatic epoxy resin may include at least two epoxy functional groups. For example, the liquid aromatic epoxy resin may include bisphenol A epoxy resin, bisphenol F epoxy resin, naphthalene epoxy resin, aminophenol epoxy resin, or a combination thereof. For example, the structure of the bisphenol A epoxy resin may be

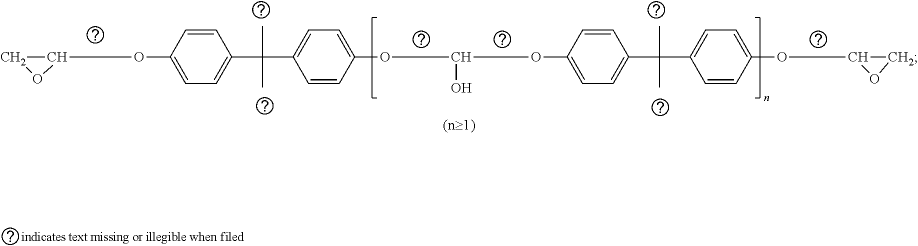

and the structure of the bisphenol F epoxy resin may be

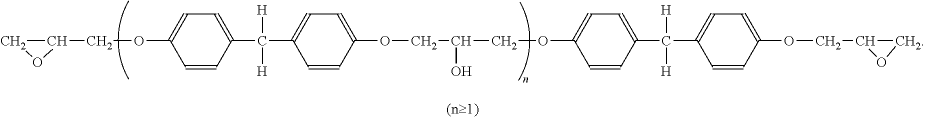

According to embodiments of the disclosure, the aromatic multi-amine compound of the disclosure may be a liquid aromatic multi-amine compound having at least two terminal amine groups. For example, the aromatic multi-amine compound may include diethyl toluene diamine, dimethylthio toluene diamine, 4,4′-methylenebis(2-ethyl)aniline, poly-1,4-butanediol bis(4-aminobenzoate), or a combination thereof.

According to embodiments of the disclosure, the polymer obtained by curing the composition contains cross-linked bonds uniformly formed between the epoxy resin and the aromatic multi-amine compound. Therefore, the composition of the disclosure includes a liquid aromatic epoxy resin having at least two terminal epoxy groups and an aromatic compound having at least two terminal amine groups.

According to embodiments of the disclosure, the equivalent ratio of the liquid aromatic epoxy resin to the aromatic multi-amine compound may be 100:80 to 100:100.

According to embodiments of the disclosure, in the composition of the disclosure, the amount of microcapsule may be 0.5 wt % to 8 wt % (such as 1 wt %, 2 wt %, 3 wt %, 4 wt %, 5 wt %, 6 wt %, or 7 wt %), based on the total weight of the liquid aromatic epoxy resin. If the microcapsule content is too low, the degree of cross-linking in the cured product obtained under lower-temperature curing conditions (such as 130° C. for 4 hours) may be insufficient. If the microcapsule content is too high, the composition may become less suitable for storage at room temperature.

According to embodiments of the disclosure, the composition may further include 0.1 wt % to 10 wt % (such as 1 wt %, 2 wt %, 3 wt %, 4 wt %, 5 wt %, 6 wt %, or 7 wt %) of a coupling agent, based on the weight of the liquid aromatic epoxy resin. For example, the coupling agent may include glycidyl ether oxypropyltrimethoxysilane, trimethoxy[2-(7-oxabicyclo[4.1.0]hept-3-yl)ethyl]silane, (3-glycidoxypropyl)methyldiethoxysilane, n-hexyltrimethoxysilane, (3-mercaptopropyl)trimethoxysilane, aminoethyl aminopropyltrimethoxysilane, or a combination thereof.

Below, exemplary embodiments will be described in detail so as to be easily realized by a person having ordinary knowledge in the art. The inventive concept may be embodied in various forms without being limited to the exemplary embodiments set forth herein.

### Preparation of Isocyanate Prepolymer

### Preparation Example 1: Isocyanate Prepolymer (1)

Isophorone diisocyanate (IPDI) (0.21 mole), 2-ethyl-2-hydroxymethyl-1,3-propanediol (TMP) (0.07 mole), and anhydrous ethyl acetate (50 mL) were added to a reaction bottle. The reaction bottle was heated to 60° C. under nitrogen atmosphere. The result was stirred continuously until the isophorone diisocyanate and 2-ethyl-2-hydroxymethyl-1,3-propanediol were completely dissolved in ethyl acetate. Next, a drop of dibutyltin dilaurate (DBTDL) was added to the reaction bottle. The reaction bottle was further heated to 75° C. and allowed to react for 8 hours. Subsequently, the ethyl acetate solvent was removed via a vacuum system, obtaining Isocyanate prepolymer (1) as a white solid.

The synthesis pathway of the above reaction was as follows:

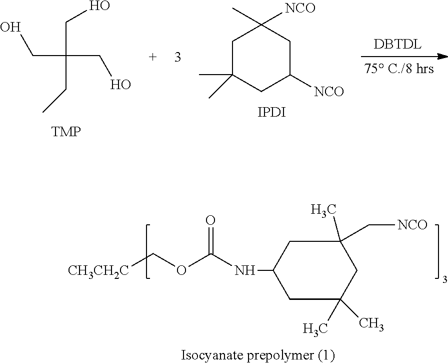

The isocyanate group content of Isocyanate prepolymer (1) was determined by the titration method according to ASTM D2572, employing 0.1N hydrochloric acid. The isocyanate group content of Isocyanate prepolymer (1) was found to be about 15 wt %.

### Preparation Example 2: Isocyanate Prepolymer (2)

4,4′-methylene diphenyl diisocyanate (MDI) (0.03 mole) and 2-ethyl-2-hydroxymethyl-1,3-propanediol (TMP) (0.07 mole) were added to anhydrous ethyl acetate (20 mL). The result was stirred at 50° C. until a homogeneous 4,4′-Methylene diphenyl diisocyanate (MDI) solution was obtained. 2-ethyl-2-hydroxymethyl-1,3-propanediol (TMP) (0.01 mole) was added to anhydrous ethyl acetate (50 mL) and stirred to obtain a 2-ethyl-2-hydroxymethyl-1,3-propanediol (TMP) solution. The 2-ethyl-2-hydroxymethyl-1,3-propanediol solution was added dropwisely to the 4,4′-methylene diphenyl diisocyanate solution under nitrogen atmosphere. Next, the result was heated to 50° C. and reacted for 5 hours. Next, the ethyl acetate solvent was removed via a vacuum system, obtaining Isocyanate prepolymer (2) as a white solid.

The synthesis pathway of the above reaction was as follows:

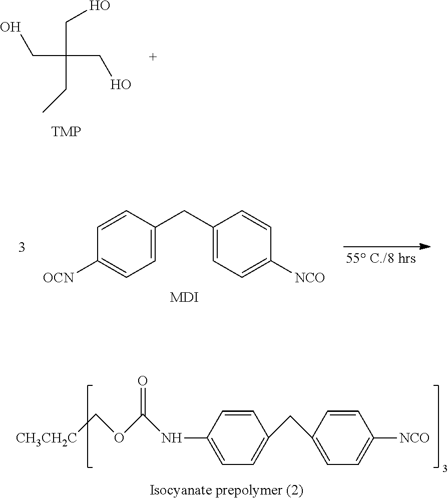

The isocyanate group content of Isocyanate prepolymer (2) was determined by the titration method according to ASTM D2572, employing 0.1N hydrochloric acid. The isocyanate group content of Isocyanate prepolymer (2) was found to be about 14 wt %.

### Preparation of Microcapsule

### Preparation Example 3: Microcapsule (1)

Deionized water (330 g), sodium dodecyl sulfate (SDS) (1.23 g), and polyvinyl alcohol (PVA) (with a weight average molecular weight ranged from about 13,000 to 23,000K g/mol) (3.96 g) were mixed to obtain a first solution. Isocyanate prepolymer (1) (13.2 g), stannous octoate (Sn(Oct)₂) (13.2 g) (used as a promoter), and anhydrous ethyl acetate (45 g) were mixed to obtain a second solution.

Next, an emulsification homogenizer was used to emulsify the first solution (aqueous phase) and the second solution (organic phase) at a speed of 10,000 rpm. After 5 minutes, the emulsified solution was transferred to a reaction tank and heated to 70° C. under nitrogen atmosphere. The reaction proceeded under mechanical stirring at 500 rpm for 15 hours, allowing Isocyanate prepolymer (1) to polymerize into polyurea which encapsulated stannous octoate. The result was then separated by centrifugation, followed by three washes with deionized water to completely remove additives such as sodium dodecyl sulfate and polyvinyl alcohol (PVA). Finally, the product was dried under vacuum at 35° C., obtaining Microcapsule (1).

Microcapsule (1) was analyzed by a focused ion beam-scanning electron microscope (FIB-SEM). A pre-deposited gold plating layer (with a thickness of about 300 to 400 nm) was applied to facilitate nano-scale sectioning of the sample at specific locations using the FIB ion beam. The results are shown in FIGURE. Next, energy dispersive X-ray spectroscopy (EDS) was performed on the cross-section of Microcapsule (1), confirming the presence of tin element within the microcapsule.

### Preparation Example 4: Microcapsule (2)

Preparation Example 4 was performed in the same manner as the method for preparing Microcapsule (1) disclosed in Preparation Example 3, except that the amount of Isocyanate prepolymer (1) was reduced from 13.2 g to 11.5 g, and the amount of stannous octoate was increased from 13.2 g to 14.9 g, to obtain Microcapsule (2).

### Preparation Example 5: Microcapsule (3)

Preparation Example 5 was performed in the same manner as the method for preparing Microcapsule (1) disclosed in Preparation Example 3, except that the amount of Isocyanate prepolymer (1) was reduced from 13.2 g to 10.1 g, and the amount of stannous octoate was increased from 13.2 g to 16.3 g, to obtain Microcapsule (3).

### Preparation Example 6: Microcapsule (4)

Preparation Example 6 was performed in the same manner as the method for preparing Microcapsule (1) disclosed in Preparation Example 3, except that 13.2 g of Isocyanate prepolymer (1) was replaced with 15.8 g of Isocyanate prepolymer (2), and the amount of stannous octoate was reduced from 13.2 g to 10.5 g, to obtain Microcapsule (4).

### Preparation Example 7: Microcapsule (5)

Preparation Example 7 was performed in the same manner as the method for preparing Microcapsule (1) disclosed in Preparation Example 3, except that 13.2 g of Isocyanate prepolymer (1) was replaced with 23.4 g of Isocyanate prepolymer (2), and the amount of stannous octoate was reduced from 13.2 g to 2.6 g, to obtain Microcapsule (5).

### Preparation Example 8: Microcapsule (6)

Preparation Example 8 was performed in the same manner as the method for preparing Microcapsule (1) disclosed in Preparation Example 3, except that the amount of Isocyanate prepolymer (1) was reduced from 13.2 g to 5.0 g, and the amount of stannous octoate was reduced from 13.2 g to 11.6 g, to obtain Microcapsule (6).

### Preparation Example 9: Microcapsule (7)

Preparation Example 9 was performed in the same manner as the method for preparing Microcapsule (1) disclosed in Preparation Example 3, except that the reaction was conducted using only mechanical stirring at a speed of 500 rpm (without the use of an emulsifying homogenizer), to obtain Microcapsule (7).

### Preparation Example 10: Microcapsule (8)

Preparation Example 10 was performed in the same manner as the method for preparing Microcapsule (1) disclosed in Preparation Example 3, except that stannous octoate was replaced with chromium(III) octoate (Cr(Oct)₃) (serving as the promoter), to obtain Microcapsule (8).

### Preparation Example 11

Preparation Example 11 was performed in the same manner as the method for preparing Microcapsule (1) disclosed in Preparation Example 3, except that stannous octoate was replaced with Zirconium tetrakis(acetylacetonate) (Zr(acac)₄) (serving as the promoter) and Isocyanate prepolymer (1) was replaced with Isocyanate prepolymer (2). After centrifugation and drying, aggregation of the product was observed, and no particulate microcapsules could be obtained.

### Preparation Example 12

Preparation Example 12 was performed in the same manner as the method for preparing Microcapsule (1) disclosed in Preparation Example 3, except that stannous octoate was replaced with zinc(II) acetylacetonate (Zn(acac)₂) (serving as the promoter). After centrifugation and drying, aggregation of the product was observed, and no particulate microcapsules could be obtained.

### Preparation Example 13

Preparation Example 13 was performed in the same manner as the method for preparing Microcapsule (1) disclosed in Preparation Example 3, except that stannous octoate was replaced with dibutyltin dilaurate (DBTDL) (serving as the promoter). After centrifugation and drying, aggregation of the product was observed, and no particulate microcapsules could be obtained.

Next, the particle size distribution D50 of Microcapsules (1) to (8) was measured, and the weight percentage of the promoter in Microcapsules (1) to (8) was evaluated, and the results are shown in Table 1. Herein, the particle size distribution D50 of the microcapsules was determined by dynamic light scattering (DLS). The weight percentage of the promoter in the microcapsules was evaluated using a solvent extraction method, which includes the following steps. The purified and dried microcapsules (with a weight of W0) were mixed with anhydrous ethyl acetate. The result was heated under reflux at 75° C. and stirred for 8 hours. After cooling to room temperature, the solid and liquid phases were separated by centrifugation, and the solid was collected. Next, the collected solid was washed with ethyl acetate and subjected to centrifugation again. These steps were repeated twice. The final obtained polyurea solid was dried under vacuum at 35° C., and after drying, the material was weighed (weight W1). Finally, the amount of promoter in the microcapsule was calculated using Equation (1).

$$Equation ( 1 )$$

$$The amount of promoter in the microcapsule ( wt \% ) = \frac{W 0 - W 1}{W 0} \times 100$$

TABLE 1

| | | | | | | | amount of |
|---|---|---|---|---|---|---|---|
| | | | | | | | promoter in |
| | | | | stirring | | | the |
| reaction | | | promoter:prepolymer | speed | | D50 | microcapsule |
| condition | promoter | prepolymer | (weight ratio) | (rpm) | product | (μm) | (wt %) |
| Preparation | Sn(Oct)₂ | Prepolymer | 50:50 | 10,000 | Microcapsule | 2.6 | 29.6 |
| Example 3 | | (1) | | | (1) | | |
| Preparation | Sn(Oct)₂ | Prepolymer | 57:43 | 10,000 | Microcapsule | 3.1 | 32.8 |
| Example 4 | | (1) | | | (2) | | |
| Preparation | Sn(Oct)₂ | Prepolymer | 62:38 | 10,000 | Microcapsule | 5.8 | 36.1 |
| Example 5 | | (1) | | | (3) | | |
| Preparation | Sn(Oct)₂ | Prepolymer | 40:60 | 10,000 | Microcapsule | 1.6 | 27.8 |
| Example 6 | | (2) | | | (4) | | |
| Preparation | Sn(Oct)₂ | Prepolymer | 10:90 | 10,000 | Microcapsule | 1.4 | 6.5 |
| Example 7 | | (2) | | | (5) | | |
| Preparation | Sn(Oct)₂ | Prepolymer | 70:30 | 10,000 | Microcapsule | 10.3 | 41.8 |
| Example 8 | | (1) | | | (6) | | |
| Preparation | Sn(Oct)₂ | Prepolymer | 50:50 | 500 | Microcapsule | 413.2 | 37.5 |
| Example 9 | | (1) | | | (7) | | |
| Preparation | Cr(Oct)₃ | Prepolymer | 50:50 | 10,000 | Microcapsule | 3.5 | 19.3 |
| Example 10 | | (1) | | | (8) | | |

| | | | | | |
|---|---|---|---|---|---|
| Preparation | Zr(acac)₄ | Prepolymer | 50:50 | 10,000 | unable to form a microcapsule |
| Example 11 | | (2) | | | |
| Preparation | Zn(acac)₂ | Prepolymer | 50:50 | 10,000 | unable to form a microcapsule |
| Example 12 | | (1) | | | |
| Preparation | DBTDL | Prepolymer | 50:50 | 10,000 | unable to form a microcapsule |
| Example 13 | | (1) | | | |

As shown in Table 1, the higher the weight ratio of the promoter to the isocyanate prepolymer used for microcapsule preparation, the higher the amount of promoter in the resulting microcapsule. In addition, as demonstrated in Preparation Examples 3 and 9, the particle size of the obtained microcapsules can be controlled by adjusting the experimental parameters of the process for mixing the first solution (aqueous phase) and second solution (organic phase).

### Thermal Curing Composition

### Example 1: Thermal Curing Composition (1)

Bisphenol F epoxy compound (manufactured by DIC with a commercial name of EXA-830LVP) (with an average epoxy equivalent weight (EEW) of 162), aminophenol epoxy resin (manufactured by Mitsubishi Chemical with a commercial name of jER™ 630) (with an average epoxy equivalent weight (EEW) of 96 g/eq), 4,4′-methylenebis(2-ethylaniline) (manufactured by Nippon Kayaku with a commercial name of KHAA), diethyltoluene diamine (manufactured by Aldrich), glycidoxypropyltrimethoxysilane (used as a coupling agent), and Microcapsule (1) were mixed at room temperature via a stirring and degassing machine to prepare Thermal curing composition (1). Herein, the equivalent ratio of bisphenol F epoxy compound, aminophenol epoxy resin, 4,4′-methylenebis(2-ethylaniline), and diethyltoluene diamine was 9:1:8:2; the amount of coupling agent was 1 wt %, and the amount of Microcapsule (1) was 1 wt %, based on the total weight of the bisphenol F epoxy compound and aminophenol epoxy resin.

### Example 2: Thermal Curing Composition (2)

Example 2 was performed in the same manner as the method for preparing Thermal curing composition (1) disclosed in Example 1, except that the amount of Microcapsule (1) was increased from 1 wt % to 3 wt %, to obtain Thermal curing composition (2).

### Example 3: Thermal Curing Composition (3)

Example 3 was performed in the same manner as the method for preparing Thermal curing composition (1) disclosed in Example 1, except that the amount of Microcapsule (1) was increased from 1 wt % to 5 wt %, to obtain Thermal curing composition (3).

### Comparative Example 1: Thermal Curing Composition (4)

Comparative Example 1 was performed in the same manner as the method for preparing Thermal curing composition (1) disclosed in Example 1, except that the Microcapsule (1) was not added, to obtain Thermal curing composition (4).

### Comparative Example 2: Thermal Curing Composition (5)

Comparative Example 1 was performed in the same manner as the method for preparing Thermal curing composition (1) disclosed in Example 1, except that the Microcapsule (1) was replaced with stannous octoate (Sn(Oct)₂), to obtain Thermal curing composition (5).

### Viscosity Stability Test

The viscosity stability of Thermal curing compositions (1) to (5) was evaluated, and the results are shown in Table 2. The evaluation method for viscosity stability was as follows. First, the viscosity (V1) of thermal curing compositions was measured immediately at 25° C. after the thermal curing composition was prepared. Next, the thermal curing composition was stood at 25° C. for 7 hours, and then the viscosity (V2) of thermal curing compositions was measured again, and the viscosity increase degree was calculated (via the equation: [(V2−V1)/V1]×100) %. The viscosity was measured by a viscometer (Brookfield DV-III Ultra).

### Reactivity Analysis

The gel time of Thermal curing compositions (1) to (5) was evaluated, and the results are shown in Table 2. The method for evaluating the gel time was as follows. A gel tester was used to analyze the trend of viscosity change over time for the thermal curing composition at 130° C. The time point at which the viscosity of the thermal curing composition rapidly increased was defined as the gel time.

TABLE 2

| | | viscosity stability | | | |
|---|---|---|---|---|---|
| | | | | viscosity | gel |
| | | V1 | V2 | increase | time |
| | | (cP) | (cP) | degree (%) | (minutes) |
| Example 1 | Thermal curing | 1515 | 1745 | 15% | 20.7 |
| | composition (1) | | | | |
| Example 2 | Thermal curing | 1550 | 1860 | 20% | 15.1 |
| | composition (2) | | | | |
| Example 3 | Thermal curing | 1648 | 2010 | 22% | 11.4 |
| | composition (3) | | | | |
| Comparative | Thermal curing | 1359 | 1576 | 12% | 38.5 |
| Example 1 | composition (4) | | | | |
| Comparative | Thermal curing | 1298 | 2980 | 153% | 15.2 |
| Example 2 | composition (5) | | | | |

As shown in Table 2, in comparison with Comparative Example 1, Thermal curing compositions (1) to (3) in Examples 1 to 3 included the microcapsule of the disclosure. Therefore, the thermal curing compositions exhibited storage stability at room temperature (with a viscosity increase of less than 25% after 7 hours at room temperature), and the thermal curing compositions were capable of rapid gelation at a relatively low curing temperature (with a gel time of less than 21 minutes at 130° C.). As a result, the thermal curing compositions in Examples 1 to 3 remained usable in the production process without becoming too viscous. Furthermore, the microcapsules of the thermal curing compositions enhanced the reaction rate between the epoxy resin and the aromatic amine hardener, resulting in that the thermal curing composition of the disclosure can be cured at lower temperatures for a reduced curing time, thereby improving production efficiency and lowering energy consumption. In addition, in comparison with Examples 1 to 3, Thermal curing composition (5) of Comparative Example 2 employed a unencapsulated promoter (i.e., stannous octoate (Sn(Oct)₂) was used instead of the microcapsule and directly mixed with the epoxy resin and aromatic amine hardener). This resulted in that Thermal curing composition (5) exhibited a viscosity increase degree of up to 153%. However, such poor viscosity stability makes the application of Thermal curing composition (5) in subsequent processing more challenging, leading to increased manufacturing difficulty and lowered product yield.

Curing Conditions of Thermal Curing Composition and Properties Evaluation after Curing

### Example 4

Two stainless steel molds (with a size of 0.5 mm×1 cm×10 cm) were provided, and Thermal curing composition (1) was placed into each mold. Next, one stainless steel mold was placed in an oven and heated at 130° C. for 4 hours to obtain Cured layer (1). In addition, another stainless steel mold was placed in an oven and heated at 150° C. for 2 hours, obtaining Cured layer (2).

### Example 5

Example 5 was performed in the same manner as the method for preparing Cured layers (1) and (2) disclosed in Example 4, except that Thermal curing composition (1) was replaced with Thermal curing composition (2), to obtain Cured layers (3) and (4).

### Example 6

Example 6 was performed in the same manner as the method for preparing Cured layers (1) and (2) disclosed in Example 4, except that Thermal curing composition (1) was replaced with Thermal curing composition (3), to obtain Cured layers (5) and (6).

### Comparative Example 3

Three stainless steel molds (with a size of 0.5 mm×1 cm×10 cm) were provided, and Thermal curing composition (4) was placed into each mold. Next, one stainless steel mold was placed in an oven and heated at 130° C. for 4 hours to obtain cured layer (7). In addition, a second stainless steel mold was placed in an oven and heated at 150° C. for 2 hours, obtaining Cured layer (8). Furthermore, a third stainless steel mold was placed in an oven and heated at 150° C. for 4 hours, obtaining Cured layer (9).

### Comparative Example 4

Thermal curing composition (5) was placed into a stainless steel mold. Next, the stainless steel mold was placed in an oven and heated at 130° C. for 4 hours, obtaining Cured layer (10). Next, Cured layers (1) to (10) were cut into test specimens with a size of 0.5 mm×1 cm×7 cm, and the modulus and glass transition temperature (Tg) of the test specimens were measured. The results are shown in Table 3. The elastic modulus and glass transition temperature were measured using a dynamic mechanical analyzer (DMA).

TABLE 3

| | | | | | glass |
|---|---|---|---|---|---|
| | | curing | | | transition |
| | | temper- | curing | elastic | temper- |
| | thermal curing | ature | time | modulus | ature |
| | composition | (° C.) | (hours) | (GPa) | (° C.) |
| Cured layer | Thermal curing | 130 | 4 | 2.47 | 127.8 |
| (1) | composition (1) | | | | |
| Cured layer | Thermal curing | 150 | 2 | 2.41 | 128.5 |
| (2) | composition (1) | | | | |
| Cured layer | Thermal curing | 130 | 4 | 2.41 | 129.5 |
| (3) | composition (2) | | | | |
| Cured layer | Thermal curing | 150 | 2 | 2.49 | 130.3 |
| (4) | composition (2) | | | | |
| Cured layer | Thermal curing | 130 | 4 | 2.60 | 130.1 |
| (5) | composition (3) | | | | |
| Cured layer | Thermal curing | 150 | 2 | 2.73 | 130.6 |
| (6) | composition (3) | | | | |
| Cured layer | Thermal curing | 130 | 4 | 2.45 | 123.4 |
| (7) | composition (4) | | | | |
| Cured layer | Thermal curing | 150 | 2 | 2.16 | 126.9 |
| (8) | composition (4) | | | | |
| Cured layer | Thermal curing | 150 | 4 | 2.38 | 130.1 |
| (9) | composition (4) | | | | |
| Cured layer | Thermal curing | 130 | 4 | 2.39 | 129.3 |
| (10) | composition (5) | | | | |

Cured layers (1), (3), (5), and (7) were all cured under the same conditions at 130° C. for 4 hours. In comparison with Cured layer (7), Cured layers (1), (3), and (5), which were prepared by the thermal curing composition of the disclosure, exhibited significantly higher glass transition temperatures (i.e., these cured layers had a higher degree of cross-linking), indicating that the thermal curing composition of the disclosure possesses relatively higher reactivity at 130° C. Furthermore, in order to achieve the same degree of cross-linking in the cured layer formed from Thermal curing composition (4) (i.e., without the addition of a promoter) as in the cured layers of the disclosure, the curing temperature of Thermal curing composition (4) had to be increased to 150° C., and the curing time had to be extended to 4 hours. On the other hand, in comparison with Cured layer (10), although the thermal curing composition of the disclosure replaced the promoter with a microcapsule, the microcapsule was able to release the encapsulated promoter upon heating. This ensured that the thermal curing composition of the disclosure could still be cured at 130° C. while maintaining high elastic modulus and glass transition temperature.

Accordingly, the metal promoter within the microcapsule remains unreactive with other components of the composition at room temperature due to the protection of the polyurea cladding. When heating the composition of the disclosure, the microcapsule softens and releases the promoter to accelerating the curing process, thereby reducing the reaction temperature and conserving energy. Accordingly, by incorporating the microcapsule of the disclosure along with a liquid aromatic epoxy resin and an aromatic polyamine compound, the composition of the disclosure can achieve rapid curing at a relatively low temperature (such as 130° C. to 150° C.) within a short duration (such as 2 to 4 hours), while simultaneously maintaining good reactivity and storage stability.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A microcapsule, comprising:
an organometallic promoter which is an organotin compound, organochromium compound, or a combination thereof; and
a polyurea, wherein the polyurea encapsulates the organometallic promoter, wherein an amount of organometallic promoter in the microcapsule is 5 wt % to 50 wt %, based on the weight of the microcapsule.

2. The microcapsule as claimed in claim 1, wherein the organometallic promoter is stannous octoate, tin(II) acetylacetonate, tin(II) acetate, tin(II) oxalate, chromium(III) octoate, chromium(III) acetylacetonate, chromium(III) acetate, chromium(III) oxalate, or a combination thereof.

3. The microcapsule as claimed in claim 1, wherein the polyurea is a polymer of an isocyanate prepolymer.

4. The microcapsule as claimed in claim 3, wherein the isocyanate prepolymer has a structure of Formula (I) 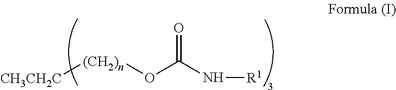
wherein n is 1, 2, 3, 4, 5, or 6; and R¹ is independently

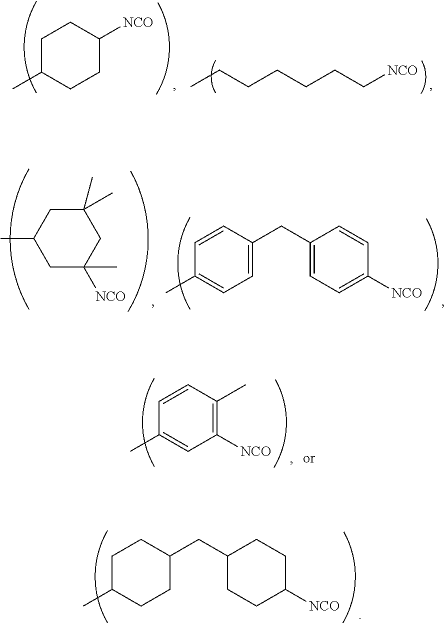

5. The microcapsule as claimed in claim 1, wherein a particle size distribution D50 of the microcapsule is 0.5 μm to 600 μm.

6. A composition, comprising:
a liquid aromatic epoxy resin;
an aromatic multi-amine compound; and
the microcapsule as claimed in claim 1.

7. The composition as claimed in claim 6, wherein
an equivalent ratio of the liquid aromatic epoxy resin to the aromatic multi-amine compound is 100:80 to 100:100.

8. The composition as claimed in claim 6, wherein an amount of microcapsule is 0.5 wt % to 8 wt %, based on the total weight of the liquid aromatic epoxy resin.

9. The composition as claimed in claim 6, wherein the liquid aromatic epoxy resin is bisphenol A epoxy resin, bisphenol F epoxy resin, naphthalene epoxy resin, aminophenol epoxy resin, or a combination thereof.

10. The composition as claimed in claim 6, wherein the aromatic multi-amine compound is diethyl toluene diamine, dimethylthio toluene diamine, 4,4′-methylenebis(2-ethyl)aniline, poly-1,4-butanediol bis(4-aminobenzoate), or a combination thereof.
